(19) United States
(12) Patent Application Publication
(10) Pub. No.: US 2020/0192836 A1
(43) Pub. Date: Jun. 18, 2020

(54) MULTIPLE-PATH THUNDERBOLT STORAGE APPARATUS AND SYSTEM

(71) Applicant: QNAP SYSTEMS, INC., New Taipei City (TW)

(72) Inventor: SHANG CHENG YEH, NEW TAIPEI CITY (TW)

(21) Appl. No.: 16/658,208

(22) Filed: Oct. 21, 2019

(30) Foreign Application Priority Data
Dec. 14, 2018 (TW) 107145289

(51) Int. Cl. G06F 13/16; G06F 13/40; G06F 13/42

(52) U.S. Cl. CPC G06F 13/1684; G06F 2213/0026; G06F 13/4282; G06F 13/4027

(57) ABSTRACT

A multiple-path thunderbolt storage apparatus and a multiple-path thunderbolt storage system are provided. The multiple-path thunderbolt storage apparatus includes a storage-processing unit and a storage unit. The storage-processing unit includes at least two terminal units complying with Peripheral Component Interconnect Express standard wherein each terminal unit is configured to be electrically coupled to a thunderbolt port and programmed to have a corresponding non-volatile memory control unit. The storage unit is electrically coupled to the at least two terminal units and includes a common storage area accessible to each non-volatile memory control unit. The multiple-path thunderbolt storage system includes the multiple-path thunderbolt storage apparatus and at least one user device which includes thunderbolt ports and a user device-processing unit.

### FIELD OF THE INVENTION

The present disclosure relates to a thunderbolt storage apparatus, and particularly to a multiple-path thunderbolt storage apparatus and system.

### BACKGROUND OF THE INVENTION

Thunderbolt interface is a standard connection interface which can provide buses for transferring instructions and data between a computer and external peripherals. With development in the technology, the latest thunderbolt interface adopts a hardware interface of universal serial bus Type-C (USB Type-C) and allows bidirectional transmission with a data rate up to 40 Gpbs. Since the common data rate has progressed from several Kbps in its infancy to several Mbps in recent years, it is predicable that the thunderbolt interface having a data rate of 40 Gpbs can not support much higher-speed transmission in the near future. Therefore, it is desired to raise the data rate to a certain extent, and it would be better to involve low development cost for this issue.

### SUMMARY OF THE INVENTION

An aspect of the present disclosure provides a multiple-path thunderbolt storage apparatus. The multiple-path thunderbolt storage apparatus includes a storage-processing unit and a storage unit. The storage-processing unit includes at least two terminal units complying with Peripheral Component Interconnect Express standard wherein each terminal unit is configured to be electrically coupled to a thunderbolt port and programmed to have a corresponding non-volatile memory control unit. The storage unit is electrically coupled to the terminal units and includes a common storage area accessible to each non-volatile memory control unit.

In an embodiment, the terminal units perform data transmission simultaneously.

In an embodiment, the storage unit is a hard disk drive or a solid-state drive.

Another aspect of the present disclosure provides a multiple-path thunderbolt storage system. The multiple-path thunderbolt storage system includes a user device set and a multiple-path thunderbolt storage apparatus. The user device set includes at least one user device, and each user device includes at least two thunderbolt ports and a user device-processing unit which is electrically coupled to the thunderbolt ports to control the thunderbolt ports. The multiple-path thunderbolt storage apparatus includes a storage-processing unit and a storage unit. The storage-processing unit includes at least two terminal units complying with Peripheral Component Interconnect Express standard wherein each terminal unit is configured to be electrically coupled to one of the thunderbolt ports and programmed to have a corresponding non-volatile memory control unit. The storage unit is electrically coupled to the terminal units and includes a common storage area accessible to each non-volatile memory control unit.

In an embodiment, the user device-processing unit controls the thunderbolt ports, which are electrically coupled to the terminal units, to simultaneously transfer data or simultaneously receive data.

In an embodiment, the user device set includes at least two user devices. For example, the user device set includes a first user device and a second user device, and the storage-processing unit includes a first terminal unit and a second terminal unit. The first terminal unit is electrically coupled to a first thunderbolt port of the first user device, and the second terminal unit is electrically coupled to a second thunderbolt port of the first user device or the second user device.

### BRIEF DESCRIPTION OF THE DRAWINGS

The advantages of the present disclosure will become more readily apparent to those ordinarily skilled in the art after reviewing the following detailed description and accompanying drawings, in which:

FIG. 1 is a circuit block diagram illustrating a multiple-path thunderbolt storage apparatus according to an embodiment of the present disclosure; and

FIG. 2 is a circuit block diagram illustrating a multiple-path thunderbolt storage system according to an embodiment of the present disclosure.

### DETAILED DESCRIPTION OF PREFERRED EMBODIMENTS

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

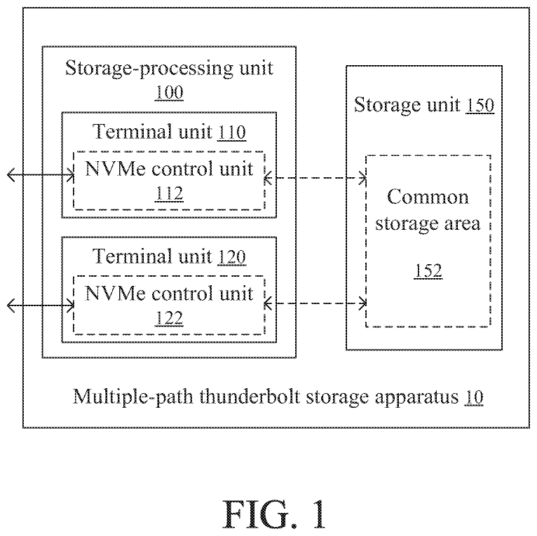

Please refer to FIG. 1, which is a circuit block diagram illustrating a multiple-path thunderbolt storage apparatus according to an embodiment of the present disclosure. In this embodiment, the multiple-path thunderbolt storage apparatus 10 includes a storage-processing unit 100 and a storage unit 150. The storage-processing unit 100 includes terminal units 110 and 120 complying with Peripheral Component Interconnect Express (PCIe) standard, and the storage unit 150 is electrically coupled to the storage-processing unit 100 and serves as an access target of the storage-processing unit 100.

In this embodiment, each of the terminal units 110 and 120 is a programmable general purpose input/output (GPIO) unit. Since the terminal units 110 and 120 comply with the PCIe standard, and a thunderbolt interface is compatible with the PCIe standard, it is derived that the terminal units 110 and 120 can establish connection to thunderbolt ports. It is to be noted that the terminal unit 110 in the embodiment will be programmed to a unit having the ability to control a non-volatile memory (NVM) for data access, especially complying with NVMe standard. From another viewpoint, a memory control unit 112 capable of controlling a NVM is generated in the terminal unit 110 through a programming method. Based on the NVMe standard, the storage unit 150 accessible to the memory control unit 112 could be a hard disk drive (HDD), a solid-state drive (SSD) or other compatible storage unit.

Similarly, a memory control unit 122 capable of controlling a NVM is also generated in the terminal unit 120 through a programming method.

The present disclosure generates the memory control unit by taking advantage of the programmable GPIO unit and the programming method, and high cost of manufacturing the hardware of the memory control unit can be avoided. Furthermore, the programming details could be easily modified to fit different applications without frequent hardware design, and such implementation has the advantage of labor saving and cost saving. The memory control unit complying with NVMe standard is called NVMe control unit hereinafter.

The terminal units 110 and 120 are electrically coupled to the storage unit 150, respectively. Concretely speaking, the terminal unit 110 accesses data on a common storage area 152 of the storage unit 150 through the NVMe control unit 112, and the terminal unit 120 accesses data on the common storage area 152 of the storage unit 150 through the NVMe control unit 122. For example, while adopting the NVMe standard, the common storage area 152 could be a namespace assigned according to the NVMe standard wherein the namespace is a common access target of the NVMe control units 112 and 122. Since both the NVMe control units 112 and 122 have access to the common storage area 152, only one of the NVMe control units 112 and 122 may be used to perform the access if a single access path is enough. Thus, the other idle NVMe control unit could serve as a backup NVMe control unit. The backup NVMe control unit will take over the access task from the NVMe control unit in use when any problem occurs on the currently used NVMe control unit or corresponding access path. Such design can enhance reliability of the data transmission.

Otherwise, if a single access path can not provide sufficient data access rate or loading balance between the access paths is taken into consideration, both the NVMe control units 112 and 122 can access data at different locations of the common storage area 152 simultaneously and perform data transmission at the same time to effectively increase the overall data access rate.

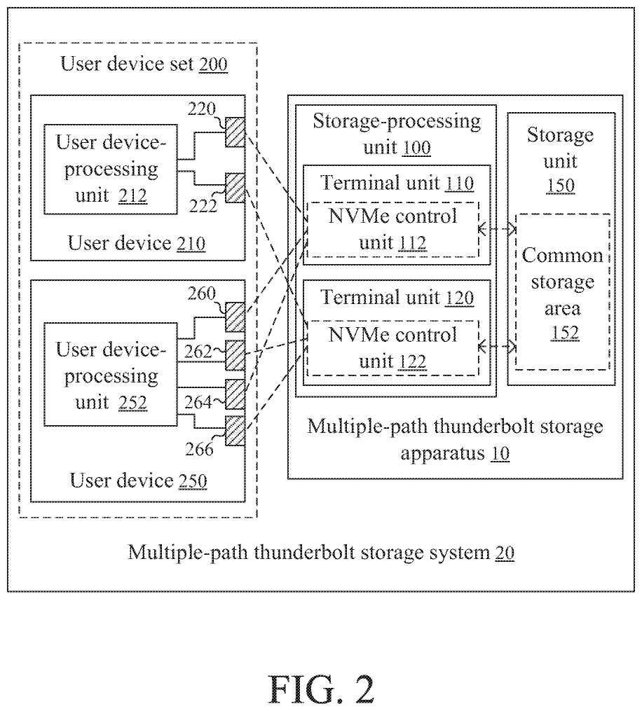

The multiple-path thunderbolt storage apparatus 10 of the present disclosure or its variations could be used in a multiple-path thunderbolt storage system. Please refer to FIG. 2, which is a circuit block diagram illustrating a multiple-path thunderbolt storage system according to an embodiment of the present disclosure. In the embodiment, the multiple-path thunderbolt storage system 20 includes the multiple-path thunderbolt storage apparatus 10 as described above and a user device set 200. Please refer to FIG. 1 and relative description about the multiple-path thunderbolt storage apparatus 10, and similar details thereof are not given herein.

According to the present disclosure, the user device set 200 includes at least one user device, but the quantity of the user device is not limited to any embodiment. As shown in FIG. 2, in this embodiment, the user device set 200 includes two user devices 210 and 250. Concretely, the user device 210 includes a user device-processing unit 212 and two thunderbolt ports 220 and 222; and the user device 250 includes a user device-processing unit 252 and four thunderbolt ports 260, 262, 264 and 266. The user device-processing unit 212 is electrically coupled to the thunderbolt ports 220 and 222 to control the thunderbolt ports 220 and 222 so that the thunderbolt ports 220 and 222 can perform data transmission simultaneously. For example, both thunderbolt ports 220 transfer data simultaneously or receive data simultaneously. The user device-processing unit 252 is electrically coupled to the thunderbolt ports 260, 262, 264 and 266 to control the thunderbolt ports 260, 262, 264 and 266 so that at least two of the thunderbolt ports 260, 262, 264 and 266 can perform data transmission simultaneously.

In order to transfer data between the multiple-path thunderbolt storage apparatus 10 and the user device set 200, the terminal units 110 and 120 of the multiple-path thunderbolt storage apparatus 10 should be electrically coupled (cable connection or wireless connection) to at least one of the thunderbolt ports 220, 222, 260, 262, 264 and 266. As shown in FIG. 2, the terminal unit 110 is designed to be electrically coupled to the thunderbolt ports 220, 260 and 264, and the terminal unit 120 is designed to be electrically coupled to the thunderbolt ports 222, 262 and 266. It is to be noted that the connection relations between the terminal units 110, 120 and the thunderbolt ports 220, 222, 260, 262, 264, 266 are not limited to this embodiment, and could be changed or modified to meet real conditions.

For example, when the terminal unit 110 is electrically coupled to the thunderbolt port 220 and the terminal unit 120 is electrically coupled to the thunderbolt port 222, a dual-path communication is established between the user device 210 and the multiple-path thunderbolt storage apparatus 10. If just one access path is sufficient for the data transmission with a desired data access rate, a single access path is used for data transmission. Thus, another idle access path serves as a backup access path and would take over the data transmission when the currently used access path goes wrong. Such design can ensure and maintain reliability of the data transmission. Otherwise, if a single access path can not provide sufficient data access rate or loading balance between the access paths is taken into consideration, both the access paths are used to perform data transmission simultaneously so as to increase the overall data access rate.

In the above embodiment, the terminal units 110 and 120 are electrically coupled to the same user device 210. In another embodiment, the terminal units 110 and 120 could be electrically coupled to respective user devices. For example, the terminal unit 110 is electrically coupled to one thunderbolt port (e.g. thunderbolt port 220) of the user device 210, and the terminal unit 120 is electrically coupled to one thunderbolt port (e.g. thunderbolt port 262) of the user device 250. Therefore, data transmission is performed between the user devices 210, 250 and the multiple-path thunderbolt storage apparatus 10 simultaneously.

In conclusion, the present disclosure allows a storage unit to be electrically coupled to the thunderbolt interface through multiple access paths. According to the concept, multiple access paths coupled to the thunderbolt interface are established for data transmission. Such design can increase the reliability or the data access rate of the data transmission of the multiple-path thunderbolt storage apparatus and system.

While the disclosure has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multiple-path thunderbolt storage apparatus comprising:
a storage-processing unit comprising at least two terminal units complying with Peripheral Component Interconnect Express standard wherein each of the terminal units is configured to be electrically coupled to a thunderbolt port and programmed to have a corresponding non-volatile memory control unit; and
a storage unit electrically coupled to the at least two terminal units and comprising a common storage area accessible to each of the non-volatile memory control units.

2. The multiple-path thunderbolt storage apparatus according to claim 1, wherein the at least two terminal units perform data transmission simultaneously.

3. The multiple-path thunderbolt storage apparatus according to claim 1, wherein the storage unit is a hard disk drive.

4. The multiple-path thunderbolt storage apparatus according to claim 1, wherein the storage unit is a solid-state drive.

5. A multiple-path thunderbolt storage system comprising:
a user device set comprising at least one user device, each of the at least one user device comprising:
at least two thunderbolt ports; and
a user device-processing unit electrically coupled to the at least two thunderbolt ports to control the thunderbolt ports; and
a multiple-path thunderbolt storage apparatus comprising:
a storage-processing unit comprising at least two terminal units complying with Peripheral Component Interconnect Express standard wherein each of the terminal units is configured to be electrically coupled to one of the at least two thunderbolt ports and programmed to have a corresponding non-volatile memory control unit; and
a storage unit electrically coupled to the at least two terminal units and comprising a common storage area accessible to each of the non-volatile memory control units.

6. The multiple-path thunderbolt storage system according to claim 5, wherein the user device-processing unit controls the at least two thunderbolt ports, which are electrically coupled to the at least two terminal units, to simultaneously transfer data or simultaneously receive data.

7. The multiple-path thunderbolt storage system according to claim 5, wherein the storage unit is a hard disk drive.

8. The multiple-path thunderbolt storage system according to claim 5, wherein the storage unit is a solid-state drive.

9. The multiple-path thunderbolt storage system according to claim 5, wherein the user device set comprises at least two user devices.

10. The multiple-path thunderbolt storage system according to claim 9, wherein the user device set comprises a first user device and a second user device, and the storage-processing unit comprises a first terminal unit and a second terminal unit,
wherein the first terminal unit is electrically coupled to a first thunderbolt port of the first user device, and the second terminal unit is electrically coupled to a second thunderbolt port of the second user device.

11. The multiple-path thunderbolt storage system according to claim 9, wherein the user device set comprises a first user device and a second user device, and the storage-processing unit comprises a first terminal unit and a second terminal unit,
wherein the first terminal unit is electrically coupled to a first thunderbolt port of the first user device, and the second terminal unit is electrically coupled to a second thunderbolt port of the first user device.
